(19) United States
(12) Patent Application Publication
(10) Pub. No.: US 2023/0207850 A1
(43) Pub. Date: Jun. 29, 2023

(54) REINFORCED PROTON EXCHANGE MEMBRANE

(71) Applicant: HYZON MOTORS INC., Honeoye Falls, NY (US)

(72) Inventor: Rajesh Bashyam, Delta (CA)

(21) Appl. No.: 18/074,133

(22) Filed: Dec. 2, 2022

Related U.S. Application Data
(60) Provisional application No. 63/293,459, filed on Dec. 23, 2021.

(51) Int. Cl. H01M 8/1053; H01M 8/1004; H01M 8/1069

(52) U.S. Cl. CPC H01M 8/1053; H01M 8/1004; H01M 8/1069; H01M 2250/20

(57) ABSTRACT

A reinforced proton-exchange membrane is provided that includes a first layer including a first ionomer, where the first layer has a first side and a second side. A second layer includes a graphene oxide, where the second layer has a first side and a second side, the first side of the second layer adjacent the second side of the first layer. A third layer includes a second ionomer, where the third layer has a first side and a second side, the first side of the third layer adjacent the second side of the second layer. The proton-exchange membrane can include or be formed upon a support layer, where the support layer is adjacent the first side of the first layer.

### CROSS-REFERENCE TO RELATED APPLICATIONS

This application claims the benefit of U.S. Provisional Application No. 63/293,459, filed on Dec. 23, 2021. The entire disclosure of the above application is hereby incorporated herein by reference.

### FIELD

The present technology relates to reinforcement of proton-exchange membranes, including proton-exchange membranes used in membrane electrode assemblies and fuel cells including such membrane electrode assemblies.

### INTRODUCTION

This section provides background information related to the present disclosure which is not necessarily prior art.

Fuel cell systems can be used as power supplies in numerous applications, such as vehicles and stationary power plants. Such systems can deliver power economically and with environmental and other benefits. To be commercially viable, however, fuel cell systems should exhibit adequate reliability in operation, even when the fuel cell systems are subjected to conditions outside their preferred operating ranges.

Fuel cells convert reactants, namely, fuel and oxidant, to generate electric power and reaction products. Proton-exchange membrane fuel cells (PEM fuel cells), also referred to as polymer-electrolyte membrane fuel cells, can employ a membrane electrode assembly (MEA) comprised of a proton exchange membrane (e.g., proton conducting ionomer) disposed between two electrodes, namely a cathode and an anode. A catalyst typically facilitates the desired electrochemical reactions at the electrodes. Separator plates or bipolar plates, including plates providing a flow field for directing the reactants across a surface of each electrode, and/or various types of gas-diffusion media, can be disposed on each side of the MEA.

In operation, the output voltage of an individual fuel cell under load can be below one volt. Therefore, in order to provide greater output voltage, multiple fuel cells can be stacked together and can be connected in series to create a higher voltage fuel cell stack. End plate assemblies can be placed at each end of the fuel cell stack to hold the stack together and to compress the stack components. Compressive force can provide sealing and adequate electrical contact between various stack components. Fuel cell stacks can be further connected in series and/or parallel combinations with other fuel cell stacks or power sources to form larger arrays for delivering higher voltages and/or currents.

Proton-exchange membranes used in fuel cells can experience wide ranges of operating conditions, including changes with respect to relative humidity as well as temperature, where a proton-exchange membrane can be reinforced both chemically and mechanically to increase the durability of proton-exchange membrane. For example, expanded polytetrafluoroethylene (e-PTFE) can be used for membrane mechanical reinforcement, while one or more antioxidants can be included in the membrane to improve chemical stability against certain radicals, such as those generated by Fenton's reaction (e.g., hydroxyl radicals).

Accordingly, there is a continuing need for optimizing mechanical and chemical stability of a proton-exchange membrane to obtain desired performance and durability requirements for PEM fuel cells.

### SUMMARY

In concordance with the instant disclosure, optimized proton-exchange membranes, including membrane electrode assemblies and fuel cells including such proton-exchange membranes, and methods of making such proton-exchange membranes have been surprisingly discovered.

The present technology includes articles of manufacture, systems, and processes that relate to a proton-exchange membrane including a first layer, a second layer, and a third layer. The first layer includes a first ionomer and has first side and a second side. The second layer including a graphene oxide and has a first side and a second side, where the first side of the second layer is adjacent the second side of the first layer. The third layer includes a second ionomer and has a first side and a second side, where the first side of the third layer is adjacent the second side of the second layer.

Ways of making a proton-exchange membrane are provided that include disposing a first layer on a support layer, where the first layer includes a first ionomer. A second layer is disposed on the first layer, where the second layer includes graphene oxide. A third layer is disposed on the second layer, where the third layer includes a second ionomer. The support layer can be removed thereafter.

Further areas of applicability will become apparent from the description provided herein. The description and specific examples in this summary are intended for purposes of illustration only and are not intended to limit the scope of the present disclosure.

DRAWINGS

The drawing described herein is for illustrative purposes only of selected embodiments and not all possible implementations, and are not intended to limit the scope of the present disclosure.

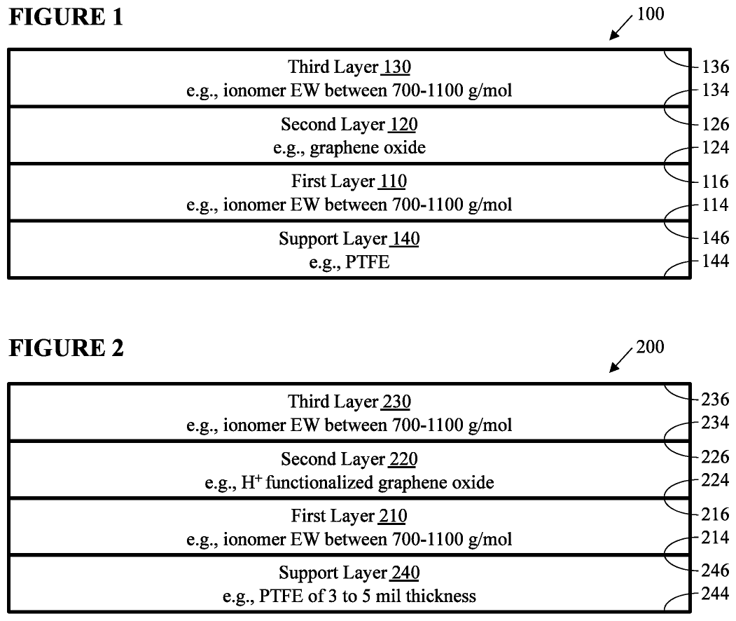

FIG. 1 is a schematic cross-sectional view of a first embodiment of a proton-conducting membrane constructed in accordance with the present technology.

FIG. 2 is a schematic cross-sectional view of a second embodiment of a proton-conducting membrane constructed in accordance with the present technology.

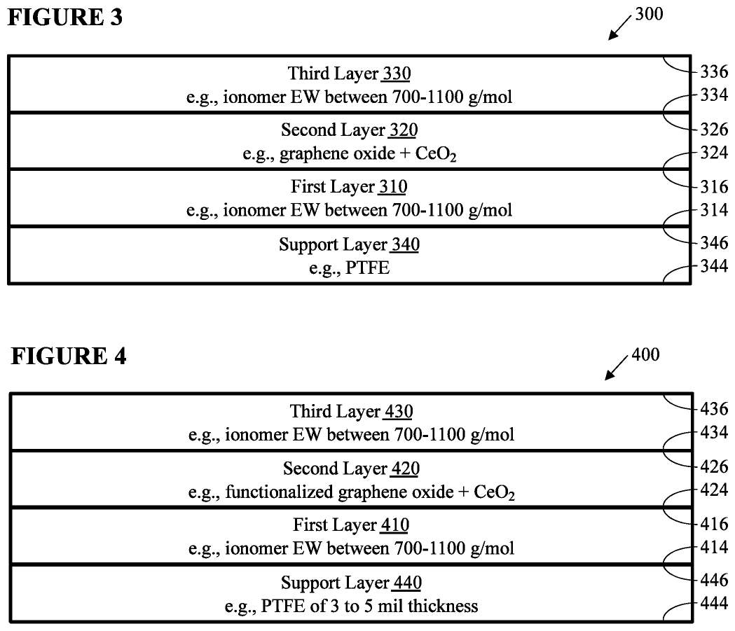

FIG. 3 is a schematic cross-sectional view of a third embodiment of a proton-conducting membrane constructed in accordance with the present technology.

FIG. 4 is a schematic cross-sectional view of a fourth embodiment of a proton-conducting membrane constructed in accordance with the present technology.

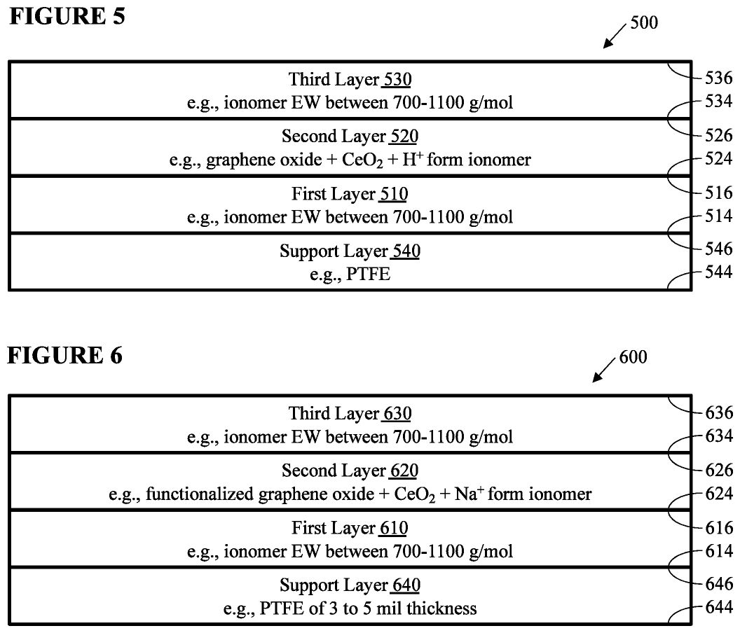

FIG. 5 is a schematic cross-sectional view of a fifth embodiment of a proton-conducting membrane constructed in accordance with the present technology.

FIG. 6 is a schematic cross-sectional view of a sixth embodiment of a proton-conducting membrane constructed in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology is drawn to optimized proton-exchange membranes that provide enhanced mechanical and chemical stability in operating environments encountered within PEM fuel cells. In this way, the proton-exchange membrane can be used to obtain desired performance and durability requirements for PEM fuel cells. Proton-exchange membranes provided herein can include a first layer, a second layer, and a third layer. The first layer can include a first ionomer and can have a first side and a second side. The second layer can include a graphene oxide and can have a first side and a second side, where the first side of the second layer can be adjacent the second side of the first layer. The third layer can include a second ionomer and can have a first side and a second side, where the first side of the third layer can be adjacent the second side of the second layer. In certain embodiments, the first side of the second layer can be directly adjacent the second side of the first layer, and the first side of the third layer can be directly adjacent the second side of the second layer. The proton-exchange membrane can also include a support layer adjacent the first side of the first layer, where the support layer can also be directly adjacent the first side of the first layer. Accordingly, the second layer can be sandwiched between the first layer and the second layer. The construction of the proton-exchange membrane provides increased mechanical stability, including improved stability in response to humidity and temperature changes, as well as increased chemical stability. Such proton-exchange membranes constructed in accordance with the present disclosure can also provide increased stability with respect to antioxidant effect provided thereby and can minimize migration of antioxidant out of the membrane.

The support layer, for example configured as a blank or a web, can be used in forming the proton-exchange membrane. For example, the support layer can provide a stable platform upon which successive layers can be disposed, applied, or formed in various ways to produce the proton-exchange membrane. The support layer can include a fluoropolymer layer that can facilitate later removal from the formed proton-exchange membrane. Certain methods of making a proton-exchange membrane include providing support layer as a blank or web, where the support layer can include a fluoropolymer layer. A first layer including the first ionomer can be disposed on or applied to the support layer. A second layer including the graphene oxide can be disposed on or applied to the first layer. A third layer including a second ionomer can be disposed on or applied to the second layer. The support layer can be removed to leave a proton-exchange membrane including the second layer sandwiched by the first layer and the second layer.

The support layer can include the following aspects. The support layer can be configured as a blank of predetermined size or a continuous web of material. The support layer can include a fluoropolymer layer. The fluoropolymer layer can include one or more various fluoropolymers, such as polytetrafluoroethylene (PTFE), polyethylenetetrafluoroethylene (ETFE), polyvinylfluoride (PVF), polyvinylidene fluoride (PVDF), polychlorotrifluoroethylene (PCTFE), perfluoroalkoxy polymer (PFA), fluorinated ethylene-propylene (FEP), polyehtylenechlorotrifluoroethylene (ECTFE), perfluorinated elastomer (FFPM), perfluoropolyether (PFPE), and perfluorosulfonic acid (PFSA). Embodiments include where the support layer consists solely of the fluoropolymer layer and where the support layer can also include other polymers, elastomers, and combinations of materials, for example, where the fluoropolymer layer can be applied as a release layer on other materials or layer(s) of materials. The release layer can be applied by spray coating or dip coating, among other means. Where the support layer includes a fluoropolymer layer, the fluoropolymer layer can have a thickness of about 0.1 mil (2.54 microns) to about 5 mil (127 microns).

Each layer including ionomer (e.g., the first layer and the second layer) can include the following aspects. Embodiments include where the ionomer in each layer is the same and other embodiments include where the ionomer in different layers is different. The ionomer can include a sulfonated tetrafluoroethylene-based fluoropolymer-copolymer; e.g., Nafion™ fluoropolymer-copolymer by DuPont. The ionomer, in the first layer and/or the third layer, for example, can have an ionomer equivalent weight (EW) of about 700 g/mol to about 1,100 g/mol. The first layer and/or the third layer can have a thickness of about 2.54 microns to about 127 microns. It is also possible to have the first layer and the third layer be substantially the same.

The second layer including the graphene oxide can include the following aspects. The graphene oxide can include a functionalized graphene oxide having various ionized units, such as sulfonic acid units. For example, graphene oxide can be functionalized in various ways to include various functional groups. Certain embodiments include where the graphene oxide can be functionalized by using 3-mercaptopropyl trimethoxysilane (MPTMS) as a sulfonic acid functional group precursor.

The second layer including the graphene oxide can also include an antioxidant. Certain embodiments include cerium oxide as the antioxidant, where the cerium oxide can be present at about 0.01 mg/² to about 0.3 mg/cm². It is also possible to have the second layer include a functionalized graphene oxide and the antioxidant (e.g., cerium oxide). Furthermore, the second layer can include a functionalized graphene oxide, antioxidant (e.g., cerium oxide), and an ionomer such as a proton form ionomer and/or a sodium form ionomer. The second layer can have a thickness of about 2.5 microns to about 5 microns.

Graphene oxide possesses excellent physical, chemical, and mechanical properties that can surprisingly enhance the proton-exchange membranes provided herein. Graphene oxide can be readily processed and coated as one or more thin films, where graphene oxide by itself can also act as a good antioxidant. The graphene oxide layer can allow protons to pass therethrough but can prevent gasses from passing therethrough, resulting in special characteristics for its use as a reinforcement layer in the present proton-exchange membranes. Graphene oxide can also be processed in an aqueous/alcoholic medium with different concentrations and can be coated as a sandwiched layer relative to the other component layers; e.g., the second layer including the graphene oxide can be sandwiched by the first layer and the third layer in construction of the proton-exchange membrane. The graphene oxide can provide reinforcement to the overall proton-exchange membrane structure.

The proton-exchange membrane can be used in various ways. A membrane electrode assembly can include one or more proton-exchange membranes as provided herein in conjunction with one or more electrodes. For example, the proton-exchange membrane can be disposed between two electrodes; e.g., a cathode and an anode. Such membrane electrode assemblies can be used in one or more fuel cells, including various fuel cell stacks. Individual fuel cells or stacks including such fuel cells having one or more proton-exchange membranes as provided herein can be used as power plants in various applications, including providing an electrical power source for a vehicle.

Various ways of making proton-exchange membranes are provided by the present technology. For example, one or more of the various component layers can be disposed on another by various means, including where successive layers are laminated, applied by one or more rollers, calendared, sprayed, or deposited onto one another to form complete layered proton-exchange membranes or partial proton-exchange membranes that are then further combined or laminated to form complete membranes. Webs of certain component layers can have other component layers applied thereto and/or transferred therefrom. Likewise, discrete blanks having predetermined dimensions of certain component layers can have other component layers applied thereto.

Certain methods of making a proton-exchange membrane can include the provision of a support layer, such as a blank or web including a fluoropolymer layer. A first layer including ionomer can be disposed on the fluoropolymer layer. A second layer including graphene oxide can be disposed on the first layer. A third layer including ionomer can be disposed on the second layer. The support layer can be removed leaving a proton-exchange membrane including the second layer sandwiched by the first layer and the second layer. Disposing various layers onto one another includes various means of application, lamination, calendaring, spraying, deposition, and other film-forming techniques, as applicable.

The present technology can accordingly extend the durability of proton-exchange membrane applications and can provide economic advantages. In some embodiments, the proton-exchange membrane can simultaneously provide increased mechanical durability and chemical durability. In other proton-exchange membranes, it has been observed that an amount of an antioxidant (e.g., CeO₂) can leach out of the proton-exchange membrane and effect fuel cell performance in a negative way. However, the proton-exchange membranes provided by the present technology can stabilize added antioxidant and minimize migration thereof out of the membrane.

### EXAMPLES

Example embodiments of the present technology are provided with reference to the several figures enclosed herewith.

With reference to FIG. 1, a first embodiment of a proton-conducting membrane is shown at 100. A first layer 110 (e.g., ionomer EW between 700-1100 g/mol) has a first side 114 and a second side 116. The first layer 110 may include, in certain examples, ePTFE and/or a porous PTFE, where ePTFE is an expanded PTFE that is also porous to accommodate the ionomer. A second layer 120 (e.g., graphene oxide) has a first side 124 and a second side 126, the first side 124 of the second layer 120 adjacent the second side 116 of the first layer 110. A third layer 130 (e.g., ionomer EW between 700-1100 g/mol) has a first side 134 and a second side 136, the first side 134 of the third layer 130 adjacent the second side 126 of the second layer 120. A support layer 140 (e.g., ePTFE) having a first side 144 and a second side 146 can be present, where the proton-conducting membrane 100 can be formed by disposing the first side 114 of the first layer 110 on the second side 146 of the support layer 140. This can be followed by sequentially or concomitantly disposing the second layer 120 on the first layer 110 and disposing the third layer 130 on the second layer 120.

With reference to FIG. 2, a second embodiment of a proton-conducting membrane is shown at 200. A first layer 210 (e.g., ionomer EW between 700-1100 g/mol) has a first side 214 and a second side 216. In certain embodiments, the first layer 210 can have a thickness ranging between 0.1 mil and 5 mil. A second layer 220 (e.g., H⁺ functionalized graphene oxide) has a first side 224 and a second side 226, the first side 224 of the second layer 220 adjacent the second side 216 of the first layer 210. A third layer 230 (e.g., ionomer EW between 700-1100 g/mol) has a first side 234 and a second side 236, the first side 234 of the third layer 230 adjacent the second side 226 of the second layer 220. A support layer 240 (e.g., ePTFE of 3 to 5 mil thickness) having a first side 244 and a second side 246 can be present, where the proton-conducting membrane 200 can be formed by disposing the first side 214 of the first layer 210 on the second side 246 of the support layer 240. This can be followed by sequentially or concomitantly disposing the second layer 220 on the first layer 210 and disposing the third layer 230 on the second layer 220.

With reference to FIG. 3, a third embodiment of a proton-conducting membrane is shown at 300. A first layer 310 (e.g., ionomer EW between 700-1100 g/mol) has a first side 314 and a second side 316. A second layer 320 (e.g., graphene oxide+CeO₂) has a first side 324 and a second side 326, the first side 324 of the second layer 320 adjacent the second side 316 of the first layer 310. A third layer 330 (e.g., ionomer EW between 700-1100 g/mol) has a first side 334 and a second side 336, the first side 334 of the third layer 330 adjacent the second side 326 of the second layer 320. A support layer 340 (e.g., ePTFE) having a first side 344 and a second side 346 can be present, where the proton-conducting membrane 300 can be formed by disposing the first side 314 of the first layer 310 on the second side 346 of the support layer 340. This can be followed by sequentially or concomitantly disposing the second layer 320 on the first layer 310 and disposing the third layer 330 on the second layer 320.

With reference to FIG. 4, a fourth embodiment of a proton-conducting membrane is shown at 400. A first layer 410 (e.g., ionomer EW between 700-1100 g/mol) has a first side 414 and a second side 416. A second layer 420 (e.g., functionalized graphene oxide +CeO₂) has a first side 424 and a second side 426, the first side 424 of the second layer 420 adjacent the second side 416 of the first layer 410. A third layer 430 (e.g., ionomer EW between 700-1100 g/mol) has a first side 434 and a second side 436, the first side 434 of the third layer 430 adjacent the second side 426 of the second layer 420. A support layer 440 (e.g., ePTFE of 3 to 5 mil thickness) having a first side 444 and a second side 446 can be present, where the proton-conducting membrane 400 can be formed by disposing the first side 414 of the first layer 410 on the second side 446 of the support layer 440. This can be followed by sequentially or concomitantly disposing the second layer 420 on the first layer 410 and disposing the third layer 430 on the second layer 420.

With reference to FIG. 5, a fifth embodiment of a proton-conducting membrane is shown at 500. A first layer 510 (e.g., ionomer EW between 700-1100 g/mol) has a first side 514 and a second side 516. A second layer 520 (e.g., graphene oxide+CeO₂+H⁺ form ionomer) has a first side 524 and a second side 526, the first side 524 of the second layer 520 adjacent the second side 516 of the first layer 510. A third layer 530 (e.g., ionomer EW between 700-1100 g/mol) has a first side 534 and a second side 536, the first side 534 of the third layer 530 adjacent the second side 526 of the second layer 520. A support layer 540 (e.g., PTFE) having a first side 544 and a second side 546 can be present, where the proton-conducting membrane 500 can be formed by disposing the first side 514 of the first layer 510 on the second side 546 of the support layer 540. This can be followed by sequentially or concomitantly disposing the second layer 520 on the first layer 510 and disposing the third layer 530 on the second layer 520.

With reference to FIG. 6, a sixth embodiment of a proton-conducting membrane is shown at 600. A first layer 610 (e.g., ionomer EW between 700-1100 g/mol) has a first side 614 and a second side 616. A second layer 620 (e.g., functionalized graphene oxide+CeO₂+Na⁺ form ionomer) has a first side 624 and a second side 626, the first side 624 of the second layer 620 adjacent the second side 616 of the first layer 610. A third layer 630 (e.g., ionomer EW between 700-1100 g/mol) has a first side 634 and a second side 636, the first side 634 of the third layer 630 adjacent the second side 626 of the second layer 620. A support layer 640 (e.g., ePTFE of 0.1 mil to 5 mil thickness) having a first side 644 and a second side 646 can be present, where the proton-conducting membrane 600 can be formed by disposing the first side 614 of the first layer 610 on the second side 646 of the support layer 640. This can be followed by sequentially or concomitantly disposing the second layer 620 on the first layer 610 and disposing the third layer 630 on the second layer 620.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A proton-exchange membrane comprising:
a first layer including a first ionomer, the first layer having a first side and a second side;
a second layer including a graphene oxide, the second layer having a first side and a second side, the first side of the second layer adjacent the second side of the first layer; and
a third layer including a second ionomer, the third layer having a first side and a second side, the first side of the third layer adjacent the second side of the second layer.

2. The proton-exchange membrane of claim 1, wherein:
the first side of the second layer is directly adjacent the second side of the first layer; and
the first side of the third layer is directly adjacent the second side of the second layer.

3. The proton-exchange membrane of claim 1, further comprising a support layer adjacent the first side of the first layer.

4. The proton-exchange membrane of claim 3, wherein the support layer is directly adjacent the first side of the first layer.

5. The proton-exchange membrane of claim 3, wherein the support layer includes a fluoropolymer.

6. The proton-exchange membrane of claim 1, wherein the first ionomer, the second ionomer, or each of the first ionomer and the second ionomer includes a sulfonated tetrafluoroethylene-based fluoropolymer-copolymer.

7. The proton-exchange membrane of claim 1, wherein the first layer and the second ionomer are substantially the same.

8. The proton-exchange membrane of claim 1, wherein the graphene oxide includes a functionalized graphene oxide having ionized units.

9. The proton-exchange membrane of claim 8, wherein the ionized units include sulfonic acid units.

10. The proton-exchange membrane of claim 1, wherein the second layer includes an antioxidant.

11. The proton-exchange membrane of claim 10, wherein the antioxidant includes cerium oxide.

12. The proton-exchange membrane of claim 1, wherein the graphene oxide includes a functionalized graphene oxide, and the second layer includes cerium oxide.

13. The proton-exchange membrane of claim 1, wherein the graphene oxide includes a functionalized graphene oxide, and the second layer includes cerium oxide and a proton form ionomer.

14. The proton-exchange membrane of claim 1, wherein the graphene oxide includes a functionalized graphene oxide, and the second layer includes cerium oxide and a sodium ion form ionomer.

15. A membrane electrode assembly comprising:
a proton-exchange membrane according to claim 1, wherein the proton-exchange membrane is disposed between two electrodes.

16. A fuel cell comprising the membrane electrode assembly according to claim 15.

17. A vehicle comprising a fuel cell according to claim 16.

18. A method of making a proton-exchange membrane, comprising:
disposing a first layer on a support layer, the first layer including a first ionomer;
disposing a second layer on the first layer, the second layer including graphene oxide; and
disposing a third layer on the second layer, the third layer including a second ionomer.

19. The method of claim 18, further comprising removing the support layer.

20. A method of making a membrane electrode assembly, comprising:
making a proton-exchange membrane according to the method of claim 18;
disposing a first electrode on one side of the proton-exchange membrane; and
disposing a second electrode on another side of the proton-exchange membrane.
